(19) United States
(12) Patent Application Publication
(10) Pub. No.: US 2014/0183386 A1
(43) Pub. Date: Jul. 3, 2014

(54) SENSING DEVICE WITH REDUCED ENERGY CONSUMPTION

(71) Applicant: AQUA - RIMAT LTD., Hod Hasharon (IL)

(72) Inventors: Moshe RAVID, Hod Hasharon (IL); Nir HASIDIM, Ein Habesor (IL)

(73) Assignee: AQUA - RIMAT LTD., Hod Hasharon (IL)

(21) Appl. No.: 13/733,341

(22) Filed: Jan. 3, 2013

(51) Int. Cl. G06F 17/00; G01F 1/00

(52) U.S. Cl. CPC G06F 17/00; G01F 1/00
USPC 251/129.01; 702/189; 702/64; 702/45

(57) ABSTRACT

The presently disclosed subject matter includes a sensor device, and a method of operating thereof. The sensor device comprises a processing unit being operatively connected to a sensor unit comprising a sensor characterized by adaptable sampling frequency. The sensor being configured to periodically sample, in a first sampling frequency, a physical quantity and generate a signal indicative of a detected physical quantity. The processing unit is configured to receive the signal and determine a detected frequency of the signal and to adapt the first sampling frequency to the detected frequency. The adapting comprising calculating a difference between the first sampling frequency and the detected frequency and instructing the sensor to increase the first frequency, if the difference is less than a first predefined value; and to decrease the first frequency, if the difference is less than a second predefined value.

### FIELD OF THE PRESENTLY DISCLOSED SUBJECT MATTER

This invention relates to the field of sensing devices and more particularly to flow sensors.

### BACKGROUND

Today, different types of sensors are used for collecting information in different applications. For example, flow sensors are used today for measuring the flow of both liquids and gases in a variety of applications. One familiar application is monitoring water flow delivered to household and business customers in order to bill the customer for water usage and possibly also for the purpose of detecting water leaks and/or water usage deviating from the norm.

One type of device which is commonly used today for measuring flow of liquid (or gas) is a flow meter device which comprises a magnetic field sensor. A magnet is attached to a turbine placed in a fluid conductor (e.g. pipe or duct). The turbine rotates, together with the attached magnet, as a result of the motion of the fluid in the conductor. The rotating magnet creates an alternating magnetic field which is detected by the sensor and can be converted into information indicative of the flow of fluid in the conductor (e.g. water flow rate).

Many applications that utilize flow meters require high accuracy. For example flow meters which are used for collecting water consumption data for billing purposes require high accuracy in order to enable accurate billing. Furthermore, highly accurate and high resolution fluid consumption data enables to more accurately detect leaks. However, accuracy comes at a cost, as accurate and sensitive sensors consume more energy.

This problem is further intensified since many flow meters are powered by a power source which is characterized by a limited lifetime such as a perishable battery. Using an external power source for powering flow meters is often problematic because flow meters are often installed in locations where connection to an external power source (e.g. an electric grid) is not possible.

Accordingly, there is a need in the art to reduce the power consumption of sensor devices, such as a flow sensor, while maintaining high resolution and high accuracy of the monitored data.

Publications considered to be relevant as background to the presently disclosed subject matter are listed below. Acknowledgement of the publications herein is not to be inferred as meaning that these are in any way relevant to the patentability of the presently disclosed subject matter.

U.S. Pat. No. 5,287,884 discloses a water flow monitoring system for determining the presence of leaks in plumbing pipes having water flowing through the pipes under high pressure includes a flow monitor which is mounted to the pipe for sensing the flow of water through the pipe. A timer and/or accumulated volume meter is associated with the flow monitor to determine when the flow has continued for a preselected period of time, and/or when the amount of water has exceeded a preselected accumulated volume threshold. Upon detection of flow for the preselected period of time, and/or preselected accumulated volume threshold, a valve is actuated to stop flow through the pipe.

U.S. Patent Application Pub. No. US2007284293 discloses a remote water meter monitoring system. A mesh network-type transceiver unit is coupled to a water meter housing having a water counting mechanism inside to transmit water consumption information as well as other sensor information, such as backflow detection, water pressure, and water metrics (e.g., residual chlorine and temperature) to a central server system via a bridge device and a corresponding mesh network. Mechanical energy from the water flowing through the water meter housing is converted to electrical energy via an energy conversion unit. An electrically powered shut off valve is remote addressable via the transceiver unit.

### GENERAL DESCRIPTION

According to one aspect of the presently disclosed subject matter there is provided a sensor device, comprising: a processing unit being operatively connected to a sensor unit comprising a sensor characterized by adaptable sampling frequency; the sensor being configured to periodically sample, in a first sampling frequency, a physical quantity and generate a signal indicative of a detected physical quantity; the processing unit is configured to receive the signal and determine a detected frequency of the signal; the processing unit is further configured to adapt the first sampling frequency to the detected frequency and thereby adapt energy consumption of said sensor unit to actual detected frequency; the adapting comprising:

calculating a difference between the first sampling frequency and the detected frequency; instructing the sensor to increase the first frequency, if the difference is less than a first predefined value; and instructing the sensor to decrease the first frequency, if the difference is less than a second predefined value.

According to another aspect of the presently disclosed subject matter there is provided a method of controlling the operation of a sensor device, the sensor device being configured to periodically sample, in a first sampling frequency, a physical quantity and generate a signal indicative of a detected physical quantity; with the help of processing unit operatively connected to the sensor unit, performing at least the following operations: receiving the signal and determining a detected frequency of the signal; calculating a difference between the first sampling frequency and the detected frequency; and instructing the sensor to increase the first frequency, if the difference is less than a first predefined value; instructing the sensor to decrease the first frequency, if the difference is less than a second predefined value; and thereby adapting energy consumption of said sensor unit to real-time detected frequency.

According to yet another aspect of the presently disclosed subject matter there is provided a processing unit: the processing unit being operatively connected to a sensor unit comprising a sensor characterized by adaptable sampling frequency; the sensor being configured to periodically sample, in a first sampling frequency, a physical quantity and generate a signal indicative of a detected physical quantity; the processing unit is configured to receive the signal and determine a detected frequency of the signal; the processing unit is further configured to adapt the first sampling frequency to the detected frequency and thereby adapt energy consumption of said sensor unit to actual detected frequency; the adapting comprising: calculating a difference between the first sampling frequency and the detected frequency; instructing the sensor to increase the first frequency, if the difference is less than a first predefined value; and instructing the sensor to decrease the first frequency, if the difference is less than a second predefined value.

According to certain embodiments of the presently disclosed subject matter the sensor is a flow sensor configured to detect flow rate of a fluid or gas in a respective conductor.

According to certain embodiments of the presently disclosed subject matter the signal is generated in response to a change in a magnetic field generated by rotating motion of a magnet in the conductor.

According to certain embodiments of the presently disclosed subject matter the sensor is a Hall Effect sensor; the physical quantity being voltage generated in the sensor as a result of a rotating magnet.

According to certain embodiments of the presently disclosed subject matter wherein the processing unit is switchable between a sleep mode and a fully operating mode; the processing unit is further configured to: count a number of detected signals in a predetermined period of time; if the processing unit is in sleep mode, switch into full operating mode, if the number is greater than a predefined threshold value; and if the processing unit is in full operating mode, switch into sleep mode, if the number is smaller than a predefined threshold value.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is high level overview of a fluid monitoring and control system, in accordance with the presently disclosed subject matter;

FIG. 2 is a functional block diagram schematically illustrating a general view of the fluid and control system, in accordance with the presently disclosed subject matter;

FIG. 3 is a functional block diagram schematically illustrating different elements of fluid monitoring and control system, in accordance with the presently disclosed subject matter;

FIG. 4 is a functional block diagram schematically illustrating a more detailed view of part of the elements illustrated in FIG. 3, in accordance with the presently disclosed subject matter;

FIG. 5 is a flowchart illustrating an example of a sequence of operations carried out in accordance with the presently disclosed subject matter; and

FIG. 6 is another flowchart illustrating an example of a sequence of operations carried out in accordance with the presently disclosed subject matter.

### DETAILED DESCRIPTION

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “receiving”, “instructing”, “adapting”, “determining”, “calculating” or the like, include actions and/or processes of a computer processor that manipulate and/or transform data into other data, said data represented as physical quantities, e.g. such as electronic quantities, and/or said data representing the physical objects.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

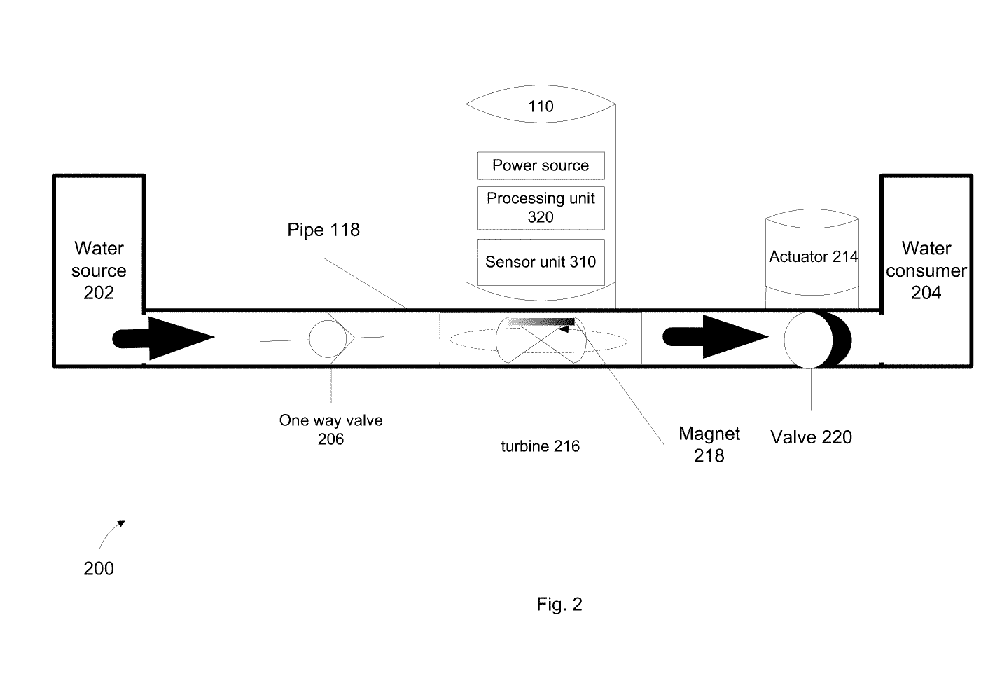

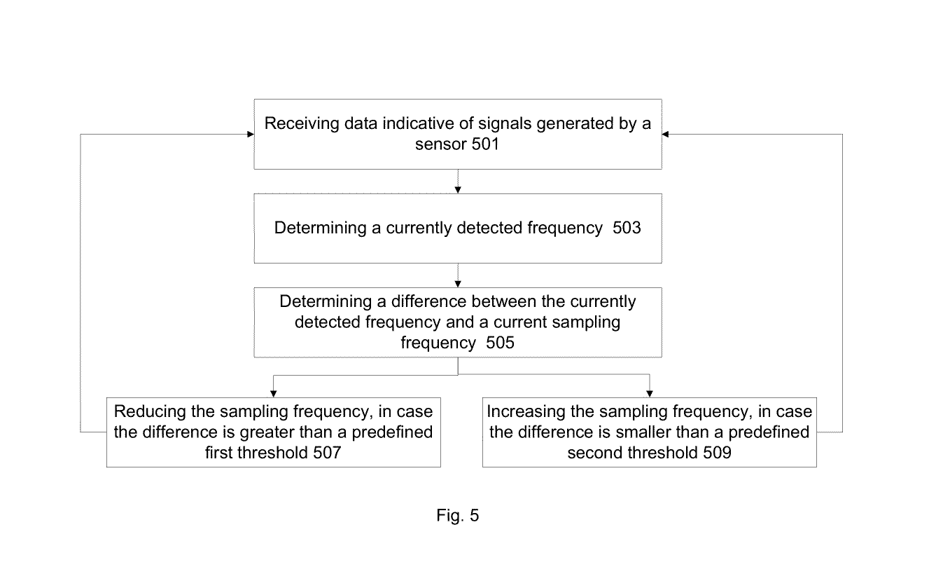

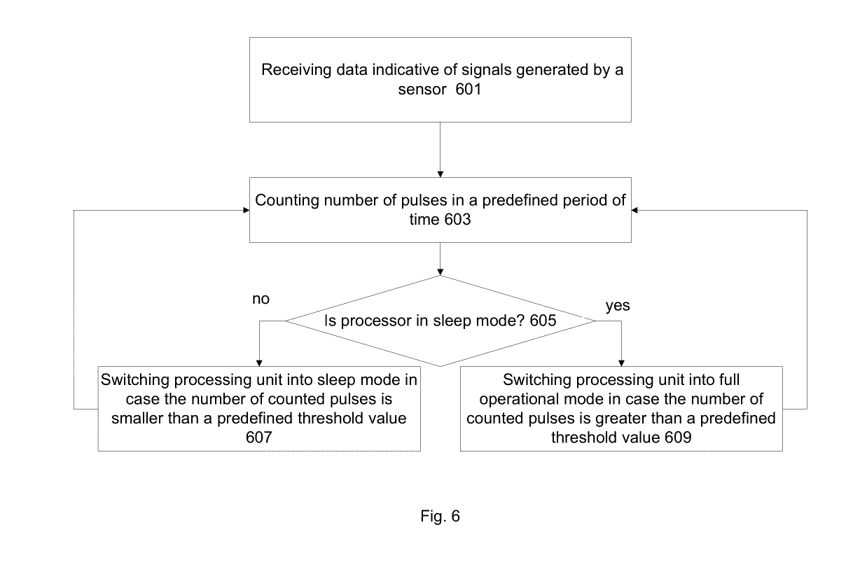

In embodiments of the presently disclosed subject matter, fewer, more and/or different stages than those shown in FIGS. 5 and 6 may be executed. In embodiments of the presently disclosed subject matter one or more stages illustrated in FIGS. 5 and 6 may be executed in a different order and/or one or more groups of stages may be executed simultaneously. FIGS. 2, 3 and 4 illustrate a general schematic of the system architecture in accordance with an embodiment of the presently disclosed subject matter. Different modules in FIGS. 2, 3 and 4 can be made up of any combination of software, hardware and/or firmware that performs the functions as defined and explained herein. The modules in FIGS. 2, 3 and 4 may be centralized in one location or dispersed over more than one location. In other embodiments of the presently disclosed subject matter, the system may comprise fewer, more, and/or different modules than those shown in FIGS. 2, 3 and 4.

The processing unit disclosed in FIGS. 2, 3 and 4 comprises or is otherwise associated with one or more computer processors. The term “computer processor” should be expansively construed to cover any kind of electronic device with data processing capabilities, including, by way of non-limiting example, a personal computer, a portable computer, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

It should be noted that the term “criterion” as used herein should be expansively construed to include any compound criterion, including, for example, several criteria and/or their logical combinations.

In the following description the presently disclosed subject matter is exemplified with reference to water flow monitoring and control. However, it should be noted that this is merely a non-limiting example and the presently disclosed subject matter can be similarly used for monitoring and controlling the flow of other fluids and gases and for applications other than flow monitoring and control.

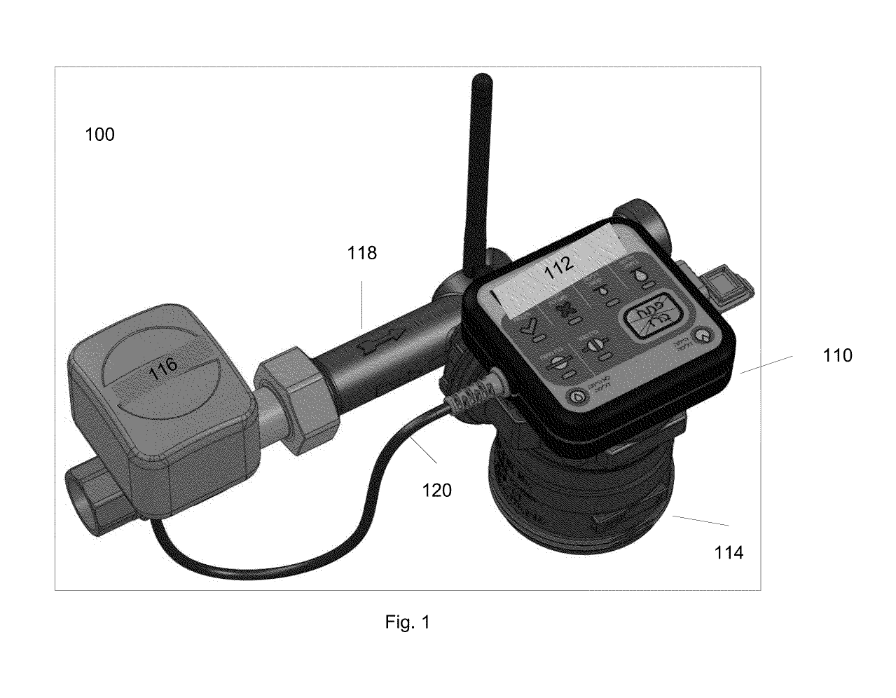

Bearing this in mind, attention is drawn to FIG. 1, which is a schematic illustration showing a high level view of a flow monitoring and control system 100 in accordance with the presently disclosed subject matter. FIG. 1 shows main unit 110 which includes user interface 112, a processing unit and a sensor unit. Main unit 110 can further include a flow meter 114 (possibly implemented as part of the processing unit) operable to calculate flow rate (e.g. of water) through the fluid conductor 118 (e.g. water pipe).

Main unit 110 is connected (e.g. via cable 120) to actuator unit 116 which includes an actuator and a valve located in pipe 118 and is operable to shut down flow in the pipe in response to a command received from processing unit 114. System 100 can further include an antenna for enabling communication between main unit 110 and a remote computer system.

FIG. 2 is a functional block diagram schematically illustrating a fluid control and monitoring system, in accordance with the presently disclosed subject matter. FIG. 2 shows water source 202 supplying water through pipe 118 to water consumer 204, which can be for example a private household or a business. The direction of water flow is indicated by the two black arrows.

Main unit 110 of water monitoring and control system is installed at the entrance to consumer 204 property. Unit 110 is operable to monitor the water flowing through pipe 118 towards the consumer's property. As mentioned above, water monitoring enables to determine water consumption and can be used by the water distributing company for billing the customer. Water monitoring can also be used for detecting water flow deviating from the norm, which may be indicative of leaks.

Main unit 110 is operatively connected to an actuator device 116 comprising a controllable actuator 214 which can close and open water valve 220 in response to instructions generated by main unit 110. For example, in case a leak is detected, main unit 110 can instruct actuator 214 to close valve 220 in order to avoid further wastage of water and potential damage which may be caused by the water leak.

Main unit 110 is fixed to the external surface of pipe 118 outside to the position of turbine 216 placed within pipe 118. Main unit 110 comprises sensor unit 310 and processing unit 320. Sensor unit 310 is configured to sense the change in magnetic field caused by the rotation of turbine 216 and attached bipolar magnet 218. The turbine's rotational speed is proportional to the water flow rate in the pipe. Based on the detected change in the magnetic field, the corresponding flow information with respect to water flow in pipe 118 can be calculated. Flow information can include for example, rate of water flow in pipe 118 (e.g. in terms of liters per minute).

One example of a sensor which is commonly used for this purpose is a Hall Effect sensor. In short, a Hall Effect sensor is designed to measure changes in voltage that appear across a conductive material, for example silicon (Si), when an electric current flowing through the conductor is influenced by a magnetic field. In a Hall Effect sensor attached to pipe 118, a transverse voltage is generated perpendicular to the applied current, as a result of a magnetic field generated by revolving magnet 218 attached to turbine 216, which is pushed by the flowing water.

Thus, sensor unit 310 can be configured to periodically sample and detect (e.g. with the help of a Hall Effect sensor) changes in the induced voltage. Based on this information, respective flow information (e.g. water flow rate) can be determined by processing unit 320.

It is noted that a magnetic field sensor in general and specifically Hall Effect sensors are merely a non-limiting example and the presently disclosed subject matter can be implemented with other types of sensors configured to detect physical quantities other than magnetic field and/or voltage. This may include for example, an optical sensor configured to detect intensities of light (being another type of physical quantity), or an ultrasonic sensor configured to detect sound (being yet another type of physical quantity) with a frequency greater than 20 kHz.

Optionally, a one way valve (OWV) 206 can be placed in pipe 118. OWV 206 enables sensor unit 320 to detect water flow characterized by low rates which otherwise would not spin the turbine and therefore would pass in pipe 118 undetected. OWV 206 allows water flow only in one direction (towards the customer marked by the black arrows). In addition OWV 206 is configured with a valve characterized by an opposing force which can be overcome only by water flowing at a pressure which is greater than that force. Thus, water flowing at low pressure, which is insufficient for overcoming the opposing force of the valve, accumulates at one side of OWV 206. Water continues to accumulate until the pressure of the accumulated water is sufficient for overcoming the force of the valve and is flowing through. The pressure of the water which can flow through OWV 206 is also sufficient for spinning the turbine and therefore the water flow is detected by sensor unit 320.

Today, known flow meter devices (such as those operating with a Hall Effect sensor) can provide high resolution flow information. In order to obtain high resolution flow information, sensor unit 320 must adapt high sampling frequency. High sampling frequency is necessary for detecting information generated in sensor unit 320 when water pressure in pipe 118 is high and accordingly rotation speed of the turbine and attached magnet is high as well. Using a sampling frequency which is lower than the rotation speed of the magnet would not be sufficient for obtaining flow information at the highest possible resolution. Indeed, some water flow monitoring units which are used today can operate at very high frequencies. For example, if a rotating turbine can reach up to 25,000 rpm, a respective Hall Effect sensor can be configured to produce around 50,000 pulses per minute (in case a bipolar magnet is used).

However, as explained above, due to the limited lifetime of power sources which are commonly used for powering flow meter devices, maintaining low power-consumption is necessary for enabling prolonged operation of the device without replenishing or replacing the power source. High frequency sampling is energy consuming and it is therefore counterproductive to the attempt at preserving energy resources. Accordingly, in order to preserve energy, a lower sampling frequency should be used. However, while lower sampling frequency (e.g. less than maximal turning frequency/speed of the turbine) would suffice for monitoring flow and obtaining flow information in lower water pressures it is not sufficient for obtaining optimal flow information during high pressure flow in the pipe.

The presently disclosed subject matter includes, inter alia, a sensor device which solves the aforementioned problems and enables to obtain high resolution (with high accuracy) information while reducing power consumption. To this end processing unit 320 is operable to control and adapt the sampling frequency of sensor 314 the real-time flow in the pipe as described in more detail below.

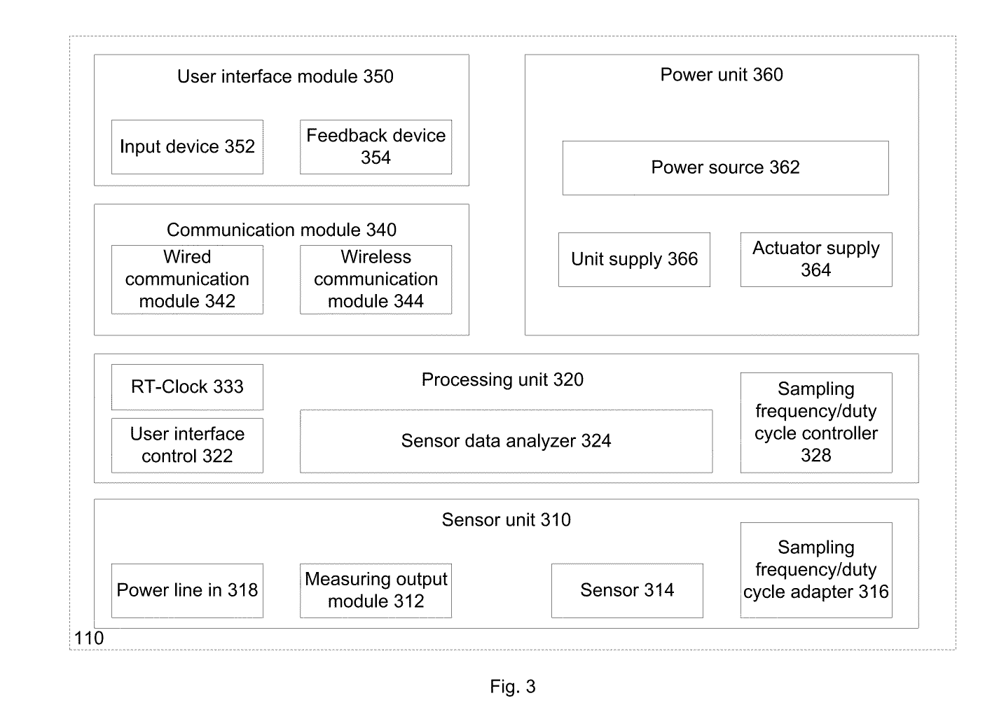

FIG. 3 is a block diagram schematically exemplifying flow monitoring and control system 300 in accordance with the presently disclosed subject matter. System 300 comprises sensor unit 310, processing unit 320, communication module 340 user interface module 350 and power unit 360.

Power unit 360 comprises a power source 362 (e.g. one or more batteries) for powering the different components in system 300. Power unit 360 can include for example a first unit (364) configured for supplying power to actuator and at least one other unit (366) configured for supplying power to other components in system 300 such as communication module 340, processing unit 320 and sensor unit 310.

User interface module 350 comprises one or more input devices 352 (e.g. buttons, levers) configured for allowing a user to input data into system 300 and one or more feedback devices 354 (e.g. lights, display screen) configured to provide to the user information generated by the system.

Communication module 340 is configured to enable communication between system 300 and remote destinations (including for example a remote household computer or a central server) and transmit information to the remote destination (e.g. water consumption information) and/or receive information from the remote destination (e.g. instructions to shut down water flow). Communication can be established via a wired communication network (via wired communication module 342) and/or wireless communication network (via wireless communication module 344 comprising one or more antennas).

Sensor unit 310 is configured in general to collect flow information indicative of the currently detected flow rate. Sensor unit 310 comprises sensor 314, measuring output module 312, sampling frequency/duty cycle adapter 316 and power line in 318 for receiving power from power unit 360.

As explained above system 300 can be fixed to the external circumference of a fluid conductor (such as water pipe 118) outside the position of a turbine located within the pipe. Sensor 314 is configured to detect flow information indicative of flow within pipe 118. For example, as mentioned above, sensor 314 can be a Hall Effect sensor, configured to sample and detect changes in the induced electric field in the sensor, resulting from the rotations of a magnet embedded within or fixed to a turbine which spins as a result of the force of flow in the pipe. Sensor 314 is configured to generate a signal in response to a change in the induced electric field detected in the sensor. For example, each time sensor 314 detects a change in the induced voltage, sensor unit 310 can be configured to generate a pulse or switch a bit from 0 to 1 or from 1 to 0 (e.g. with the help of measuring output unit 312) as a result of the detected change in the induced voltage.

Sensor 314 in unit 310 is configured with an adaptable sampling frequency. Accordingly, the sampling frequency of sensor 314 can be modified (e.g. with the help of sampling frequency/duty cycle adapter 316) to match the specific operational requirement of a given application or system.

In accordance with the teaching disclosed herein processing unit 320 (e.g. with the help of sensor data analyzer 324) is configured to receive from sensor unit 310 information indicative of the singles (e.g. pulses) generated by measuring output unit 312 and calculate a currently detected frequency of the pulses. Processing unit 320 is configured to compare the currently detected frequency (of the signals) to the current sampling frequency, (i.e. the sampling frequency currently assigned to sensor 314), which is also known to processing unit 320. Processing unit 320 is further configured to compare the difference between the currently detected frequency and the current sampling frequency of sensor 314 to a predefined criterion and based on the result of this comparison determine whether and in what manner the sampling frequency of sensor 314 should be adjusted.

The maximal frequency of the pulses which can be detected by sensor unit 310 is dependent on the sampling frequency assigned to sensor 314. Thus, if the difference between the currently detected frequency and the current sampling frequency is smaller than a predefined value, processing unit 320 can instruct (e.g. with the help of measuring frequency/duty cycle controller 328) sampling frequency/duty cycle adapter 316 in sensor unit 310 to raise the sampling frequency by a certain value. Alternatively, if the difference between the currently detected frequency and the current sampling frequency is greater than a predefined value, processing unit 320 can instruct (e.g. with the help of measuring frequency/duty cycle controller 328) sampling frequency/duty cycle adapter 316 in sensor unit 310 to lower the sampling frequency by a certain value. Sampling frequency of sensor 314 is maintained higher than the currently detected frequency in order to enable detection of a change in the currently detected frequency.

Frequency/duty cycle adapter 316 in sensor unit 310 is configured, responsive to a command issued by processing unit 320, to modify the sampling frequency assigned to sensor 314. By adapting the sampling frequency to the currently detected frequency detected in real-time, system 300 can obtain high resolution flow information when flow rate is high while avoiding unnecessary energy consumption when flow rate is low.

Processing unit 320 in FIG. 3 can further comprise real-time clock 333 and user interface control 322. User interface control 322 is configured for receiving input from a user (via user interface) and sending output data to a display in a user interface.

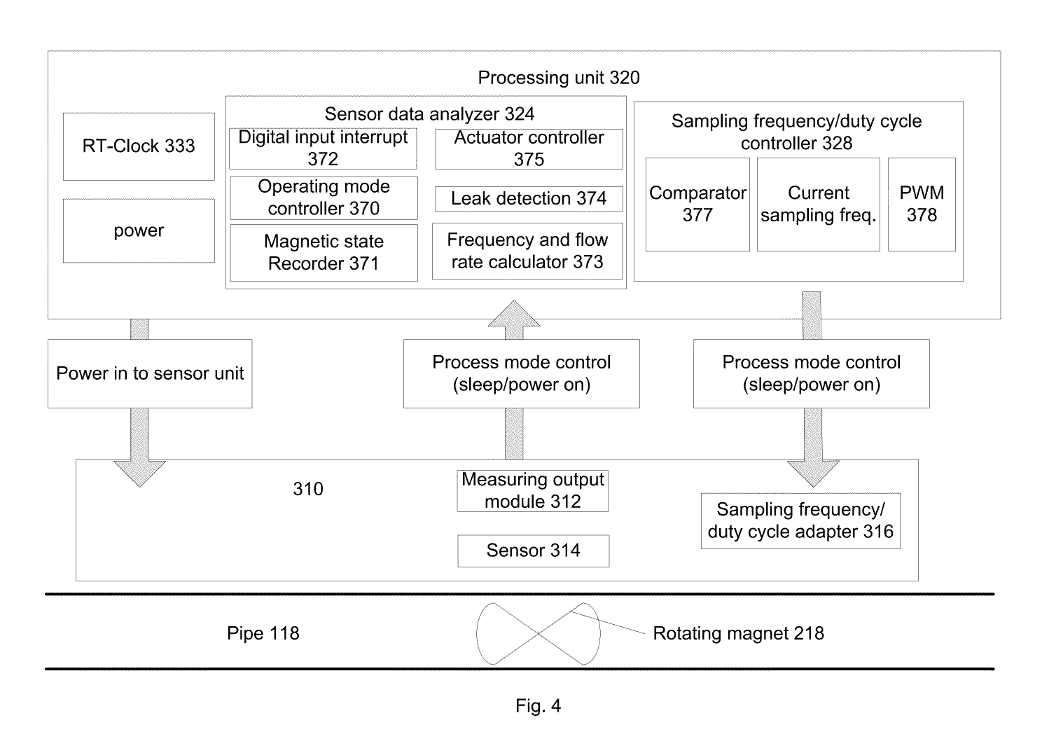

FIG. 4 is a functional block diagram schematically illustrating a more detailed view of part of the elements previously described with reference to FIG. 3, in accordance with the presently disclosed subject matter.

FIG. 4 shows a more detailed view of sensor data analyzer 324 and sampling frequency/duty cycle controller 328. As mentioned above sensor data analyzer 324 in processing unit 320 is configured to receive from sensor unit 310 data generated by sensor 314 indicative of the changing magnetic field generated by the rotating magnet in the pipe. However, when there is no flow in the pipe, no signal is being generated by sensor 314. During such periods of time, some of the operations executed by processing unit are unnecessary. For example, it is unnecessary to calculate the currently detected frequency or to compare the currently detected frequency with the current sampling frequency and adapt the sampling frequency assigned to the sensor. According to the presently disclosed subject matter in order to further reduce power consumption and improve the accuracy of flow monitoring and control system 100, processing unit 320 disclosed herein is configured to stay in sleep mode and wake up to become fully operative, only in response to a predefined number of pulses detected in sensor unit 310. When in sleep mode, only part of the elements in processing unit 320 operate, while the rest of the elements do not operate and therefore processing unit 320 consumes less energy. The elements which remain operable in sleep mode can include for example, real-time clock 333, operating mode controller 370 and power supply unit 366. Thus, during sleep mode the currently detected frequency is not calculated and processing unit 320 is only partially operable.

Operating mode controller 370, in sensor data analyzer 324, is configured in general to control the operating mode of processing unit 320. Operating mode controller 370 comprises a counter (not shown) which is configured to count each time a detected signal is recorded in magnetic state recorder 371.

Assuming processing unit 320 is in sleep mode, each signal (e.g. pulse generated in sensor unit 310) of a change in the induced voltage caused by the magnet, which is received in magnetic state recorder 371 is counted by the counter. In case the counted signals exceed a predefined value, an interrupt is generated (e.g. with the help of digital input interrupt 372) which switches processing unit 320 into a full operational mode.

When switched into full operational mode processing unit can calculate the currently detected frequency and module 328 becomes operable for adapting the sampling frequency of the sensing unit if necessary.

Similarly, assuming processing unit 320 is in full operational mode, operating mode controller 370 continues to count the recorded signals (with the help of the counter). In case the number of signals, counted during a predetermined period of time, is less than a predetermined value, operating mode controller 370 is configured to switch processing unit 320 to sleep mode. The counter can be periodically reset in order to ensure the counted signals represent a predefined minimal flow rate in the pipe.

Sensor data analyzer 324 can further comprise frequency and flow rate calculator 373, leak detection module 374 and actuator controller 375. Frequency and flow rate calculator 373 is configured to calculate, based on the information received from sensor unit 310, the frequency of the detected signals (the currently detected frequency of the signals (e.g. pulses) generated by sensor unit 310) and the flow rate.

Leak detector 375 is configured to determine, based on the calculated flow rate and additional available algorithms, whether the detected information is indicative of an ongoing leak. In case a leak is detected actuator controller can be utilized for closing valve 220 and thereby stopping the leak. Leak detector can also be configured, responsive to detection of a leak, to generate any type of user notification with respect to the detected leak (e.g. sending a text message to the user indicative of a leak in the user's property).

Sampling frequency/duty cycle controller 328 is configured to determine whether the sampling frequency assigned to sensor unit 310 should be modified, and to issue a command instructing sampling frequency/duty cycle adapter 316 to do so if a modification is required.

To this end sampling frequency/duty cycle controller 328 can store the current sampling frequency and compare (with the help of comparator 377) between the current sampling frequency and the currently detected frequency which can be obtained from frequency and flow rate calculator 373. As explained above, sampling frequency/duty cycle controller 328 is operable to modify the current sampling frequency of sensor unit 310 based on the calculated difference between the current sampling frequency and the currently detected frequency.

Modification of the current sampling frequency can be accomplished with the help of pulse width modulation (PWM) controller 378 which is configured, responsive to instructions generated by sampling frequency/duty cycle controller 328 to modulate the duty cycle of the sampling signal of sensor unit 310 and thereby modify the respective sampling frequency.

Thus, in accordance with the teaching disclosed herein, processing unit 320 is configured to utilize two feedback loops in order to reduce power consumption in a sensor device. In a first feedback loop processing unit 320 is switched between sleep mode and fully operational mode based on information received from sensor unit 310, the information being indicative of current flow rate in the monitored pipe. When in sleep mode, only when a minimal flow rate which is greater than a certain predefined threshold is identified, processing unit 320 is switched to full operative mode. When in full operational mode, processing unit 320 is switched to sleep mode if a flow rate which is less than a certain predefined threshold is identified.

Furthermore, in a second feedback loop, the information which is received from sensor unit 310, with respect to the currently detected frequency is utilized by processing unit 320 to control the sampling frequency assigned to sensor unit 310.

Both feedback loops enable to reduce the power consumption of system 300 while enabling system 300 to obtain high resolution (with high accuracy) flow information.

FIG. 5 is a flowchart illustrating an example of a sequence of operations carried out in accordance with the presently disclosed subject matter. The operations described herein can be executed for example, by processing unit 320 described above with reference to FIGS. 2-4.

At block 501 data indicative of signals (e.g. pulses) generated by a sensor is received in a processing unit. As explained above in detail the pulses can be generated in response to a detected physical quantity such as detected induced voltage resulting from a changing magnetic field, caused by movement of a magnet. However, the pulses can also be generated by other types of sensors as well. For example, signals can be generated by an optical sensor configured for measuring changes in light intensity.

The currently detected frequency of the pulses is determined (block 503). The currently detected frequency is compared to current sampling frequency, which is assigned to the sensor, and a difference between the two frequencies is determined (block 505).

In case the difference is greater than a predefined first threshold, the processing unit is operable to issue a command to reduce the sampling frequency assigned to the sensor (block 507). In case the difference is smaller than a predefined second threshold, processing unit is operable to issue a command to increase the sampling frequency which is assigned to the sensor (block 509). As explained above, modification of the sampling frequency of the sensor can be accomplished with the help of a PWM controller operable to control the sampling frequency in the sensor.

FIG. 6 is a flowchart illustrating an example of a sequence of operations carried out in accordance with the presently disclosed subject matter. The operations described here can be executed for example, by processing unit 320 described above with reference to FIGS. 2-4.

FIG. 6 demonstrates the feedback loop between the sensing unit and the processing unit in which the operation mode of the processing unit is determined based on information which is received in real-time from the sensing unit.

In a processing unit operatively connected to a sensor, unit data indicative of signals generated by the sensor is received (block 601). As explained above with reference to block 501 in FIG. 5 the signals (e.g. pulses) can be generated in response to a detected physical quantity such as detected induced voltage resulting from a changing magnetic field, caused by movement of a magnet. The processing unit is configured to count the number of pulses which are detected during a certain period of time (block 603).

If processing unit 320 is in sleep mode (“YES” in block 605) processing unit is switched into full operational mode in case the number of counted pulses is greater than a predefined threshold value (block 609).

If processing unit 320 is in full operational mode (“NO” in block 605), processing unit is switched into sleep mode in case the number of counted pulses is smaller than a predefined threshold value (block 607).

It is to be understood that the presently disclosed subject matter is not limited in its application to the details set forth in the description contained herein or illustrated in the drawings. The presently disclosed subject matter is capable of other embodiments and of being practiced and carried out in various ways. For example, the presently disclosed subject matter is not limited to magnetic sensors, and the modifications disclosed herein are applicable to other types of sensors as well. For instance, an optical sensor providing indication of changes in absorbed light intensity can also be integrated with an appropriate processing unit as disclosed herein, which is configured to adapt the sampling frequency of the sensor based on a currently detected frequency. Furthermore, the presently disclosed subject matter is not limited to monitoring and control of water flow and can be similarly used for monitoring and control of other liquids and gases. The presently disclosed subject matter can also be used for applications other than flow monitoring and control (for example, for determining the speed of a mechanical wheel).

Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

1. A sensor device, comprising:
a processing unit being operatively connected to a sensor unit comprising a sensor characterized by adaptable sampling frequency;
the sensor being configured to periodically sample, in a first sampling frequency, a physical quantity and generate a signal indicative of a detected physical quantity;
the processing unit is configured to receive the signal and determine a detected frequency of the signal;
the processing unit is further configured to adapt the first sampling frequency to the detected frequency and thereby adapt energy consumption of said sensor unit to actual detected frequency;
the adapting comprising:
calculating a difference between the first sampling frequency and the detected frequency;
instructing the sensor to increase the first frequency, if the difference is less than a first predefined value; and
instructing the sensor to decrease the first frequency, if the difference is less than a second predefined value.

2. The device according to claim 1 wherein the sensor is a flow sensor configured to detect flow rate of a fluid or gas in a respective conductor.

3. The device according to claim 2 wherein the signal is generated in response to a change in a magnetic field generated by rotating motion of a magnet in the conductor.

4. The device according to claim 1 wherein the sensor is a Hall Effect sensor; the physical quantity being voltage generated in the sensor as a result of a rotating magnet.

5. The device according to claim 1 wherein the processing unit is switchable between a sleep mode and a fully operating mode; the processing unit is further configured to:
count a number of detected signals in a predetermined period of time;
if the processing unit is in sleep mode, switch into full operating mode, if the number is greater than a predefined threshold value; and
if the processing unit is in full operating mode, switch into sleep mode, if the number is smaller than a predefined threshold value.

6. The device according to claim 1 wherein the processing unit is configured to adapt the first sampling to the detected frequency by pulse width modulation of a sampling signal.

7. The device according to claim 2 wherein the processing unit is further configured to detect a leak in the conductor, based on at least the flow rate.

8. The device according to claim 7 wherein the processing unit is operatively connected to an actuator controlling a valve configured for controlling flow in the conductor; the processing unit is configured to instruct the actuator to close the valve and stop the flow in the conductor in case a leak is detected.

9. The device according to claim 2 wherein the conductor is a pipe.

10. The device according to claim 2 wherein said fluid is water.

11. The device according to claim 1 wherein the signal is a pulse generated by the sensor.

12. The device according to claim 1 wherein said signal is indicative of a change in said physical quantity and said detected frequency is a frequency of the detected change.

13. A method of controlling the operation of a sensor device, the sensor device being configured to periodically sample, in a first sampling frequency, a physical quantity and generate a signal indicative of a detected physical quantity;
with the help of processing unit operatively connected to the sensor unit, performing at least the following operations:
receiving the signal and determining a detected frequency of the signal;
calculating a difference between the first sampling frequency and the detected frequency; and
instructing the sensor to increase the first frequency, if the difference is less than a first predefined value;
instructing the sensor to decrease the first frequency, if the difference is less than a second predefined value; and
thereby adapting energy consumption of said sensor unit to real-time detected frequency.

14. The method according to claim 13 wherein the sensor is a flow sensor, the method further comprising: detecting flow rate of a fluid or gas in a respective conductor based on said detected frequency.

15. The method according to claim 14 wherein the signal is generated in response to change in a magnetic field generated by rotating motion of a magnet in the conductor.

16. The method according to claim 13 further comprising:
counting a number of detected signals in a predetermined period of time;
if the processing unit is in sleep mode, switching into full operating mode, if the number is greater than a predefined threshold value; and
if the processing unit is in full operating mode, switching into sleep mode, if the number is smaller than a predefined threshold value.

17. The method according to claim 13 wherein adapting of the first sampling to the detected frequency is accomplished by pulse width modulation of a sampling signal.

18. The method according to claim 14 further comprising: detecting a leak in the conductor, based on at least the flow rate.

19. The method according to claim 18 further comprising:
instructing an actuator to close a valve and stop flow in the conduction if a leak is detected.

20. A processing unit:
the processing unit being operatively connected to a sensor unit comprising a sensor characterized by adaptable sampling frequency;
the sensor being configured to periodically sample, in a first sampling frequency, a physical quantity and generate a signal indicative of a detected physical quantity;
the processing unit is configured to receive the signal and determine a detected frequency of the signal;
the processing unit is further configured to adapt the first sampling frequency to the detected frequency and thereby adapt energy consumption of said sensor unit to actual detected frequency;
the adapting comprising:
calculating a difference between the first sampling frequency and the detected frequency; and
instructing the sensor to increase the first frequency, if the difference is less than a first predefined value; and
instructing the sensor to decrease the first frequency, if the difference is less than a second predefined value.
